(19) United States
(12) Patent Application Publication
(10) Pub. No.: US 2024/0018049 A1
(43) Pub. Date: Jan. 18, 2024

(54) METHOD AND DEVICE FOR PREPARING ARTIFICIAL CORE FOR PETROLEUM GEOLOGICAL EXPLORATION

(71) Applicant: YANGTZE UNIVERSITY, Jingzhou City (CN)

(72) Inventors: Yong FENG, Jingzhou City (CN); Jiguang TANG, Jingzhou City (CN); Tao FENG, Jingzhou City (CN); Jian WANG, Jingzhou City (CN)

(73) Assignee: YANGTZE UNIVERSITY, Jingzhou City (CN)

(21) Appl. No.: 18/220,502

(22) Filed: Jul. 11, 2023

(30) Foreign Application Priority Data
Jul. 12, 2022 (CN) 202210811605.3

(51) Int. Cl. C04B 28/24; C04B 14/10; C04B 14/06

(52) U.S. Cl. CPC C04B 28/24; C04B 14/10; C04B 14/06; C04B 2111/00939

(57) ABSTRACT

The present disclosure provides a method and device for preparing an artificial core for petroleum geological exploration. The method includes: step 1, establishing a relation curve between a median grain diameter of quartz sand and a permeability, determining a type and a usage amount of epoxy resin, and preparing a cementing agent according to a principle that the epoxy resin has a direct ratio with a specific surface; step 2, based on a method of controlling a core permeability, preparing benchmark sand with quartz sand of different grain sizes in a certain ratio, fabricating a low-permeability core by adjusting a ratio of the benchmark sand to fine sand, and fabricating a high-permeability core by adjusting a ratio of the benchmark sand to coarse sand; step 3, separately and proportionally weighing quartz sand of different grain diameters and putting them into a magnetic tray, manually mixing and agitating for later use.

### CROSS REFERENCE TO RELATED APPLICATION

This patent application claims the benefit and priority of Chinese Patent Application No. 202210811605.3, filed with the China National Intellectual Property Administration on Jul. 12, 2022, the disclosure of which is incorporated by reference herein in its entirety as part of the present application.

### TECHNICAL FIELD

The present disclosure relates to the technical field of petroleum geological exploration, and in particular, to a method and device for preparing an artificial core for petroleum geological exploration.

### BACKGROUND

“Geological exploration”, determining a suitable bearing stratum by exploration and probe on geology, is an investigation and research activity of determining a basic type and calculating basic parameters according to the bearing capacity of the foundation. It is also a study on geological situation, such as rock, strata, structure, minerals, hydrology and landform in a certain region. The exploration targets on discovering industrial mineral deposit, and in order to identify the mineral quality and quantity, and technical conditions for exploitation and utilization, and provide mineral reserve and geological data required for the construction and design.

A rock core is a rock sample drilled out by using a coring tool lowered into a well according to a geologically designed stratigraphic horizon and depth during exploration and development of an oil and gas field. The rock core provides most intuitive and most practical data for knowing features of an underground oil reservoir and a fluid contained therein. A natural rock core may be obtained by a sidewall coring way and a well coring way, and usually, the latter is mostly used. An appropriate number of wells must be selected within the range of an oil field, and a certain numbers of rock cores may be drilled out from related oil and gas horizons, which may be observed, analyzed and studied to obtain various characteristics of strata. However, due to a complex situation of a stratum, more core samples and high drilling cost are needed for the study. Thus, the general parameters are often obtained by studying the artificial core. It would be an economical way to explore and exploit the rule via physical model experiment of artificial core, and verify the rule via natural core.

Experimental testing is the most direct method for studying physical properties of rock with a multi-porosity structure. Physical tests like acoustic velocity, permeability and electrical conductivity on real rock could relatively realistically reflect properties of an underground oil and gas reservoir. However, the rock with the multi-porosity structure exhibits strong heterogeneity, anisotropy, and multiple scales, and it is hard to obtain a representative natural rock core from the rock with the multi-porosity structure. Moreover, underground coring is high in cost, and it is not easy to guarantee the quality of coring; experimental repeatability is poor; real rock cores are different in pore structure, which is not conducive to single-factor analysis and research, resulting in low efficiency and a long period of experimental research. Therefore, experimental data of a real rock core is mostly used for verification and correction of an ideal model and an empirical formula.

Currently, there are mainly three types of artificial cores used in petroleum geological exploration: a quartz sand and epoxy resin cemented core, a quartz sand filled core, and a quartz sand and aluminum phosphate cemented core. A fabrication method for the silica sand and epoxy resin is to cement quartz sand and epoxy resin with cementing agent, then to pressure and heat for core. The noted production method for the quartz sand or glass bead filling is to simulate the core via filling the mold with quartz sand or glass beads. The production method for quartz sand aluminum phosphate cement is to process quartz sand and aluminum phosphate then core is gained. A silica sand and epoxy resin cemented model is the most widely used.

The above-mentioned traditional methods are mostly used in physical simulation of a conventional reservoir in petroleum geological exploration. The pore diameter inside the artificial core can reach the micron level through benchmark sand prepared in a certain proportion with quartz sand of different particle sizes. However, since underground rock is a porous medium, fractures and nanoscale pores often develop in addition to conventional intergranular micron-scale pores. Therefore, a currently prepared artificial core may greatly differ from a natural rock core because of inappropriate control on porosity and hardness, and thus fail to best simulate a natural rock core for testing. Consequently, a certain influence may arises from simulation on petroleum geological exploration result.

### SUMMARY

An objective of this part is to outline some aspects of embodiments of the present disclosure and to briefly describe some preferred embodiments. Some simplification or omission may be made in this part as well as in the abstract and the title of invention of the present disclosure to avoid blurring the purposes of this part, the abstract and the title of invention, and such simplification or omission cannot be used to limit the scope of the present disclosure.

The present disclosure is provided in view of the problems existing in the prior art.

Therefore, an objective of the present disclosure is to provide a method and device for preparing an artificial core for petroleum geological exploration. The prepared artificial core may be similar to a natural rock core in physical properties, and data of a simulation experiment has little difference from actual ones.

To solve the above technical problem, according to one aspect of the present disclosure, the present disclosure provides the following technical solutions.

Provided are a method for preparing an artificial core for petroleum geological exploration. The method includes the following steps:
step 1, establishing a relation curve between a median grain diameter of quartz sand and a permeability, determining a type and a usage amount of epoxy resin, and preparing a cementing agent according to a principle that the epoxy resin has a direct ratio with a specific surface;
step 2, based on a method of controlling a core permeability, preparing benchmark sand with quartz sand of different grain sizes in a certain ratio, fabricating a low-permeability core by adjusting a ratio of the benchmark sand to fine sand, and fabricating a high-permeability core by adjusting a ratio of the benchmark sand to coarse sand;
step 3, separately and proportionally weighing quartz sand of different grain diameters and putting them into a magnetic tray, and manually mixing and agitating for later use, where since agitating frequency, times and uniformity degree for per capita have a great influence on porosity and permeability values of an artificial core during stirring, a quartz sand mixing agitator is employed to avoid man-made nonuniform agitation;
step 4, adding a clay mineral, where a clay mineral in a natural rock core plays an important role on a structure and physical properties of the rock core; according to a principle of physical simulation similarity criterion, a certain amount of clay mineral is added to an artificial core; and a special method of adding the clay mineral is used to avoid the clay mineral from being covered with the epoxy resin; and
step 5, preparing an artificial core: preparing a slightly oil-wet core by diluting silicone oil which is 10% by weight of a sand mold with 20 times petroleum ether, evenly agitating the diluted silicone oil with 40 to 70-mesh quartz sand, 70 to 140-mesh quartz sand and 140 to 200-mesh quartz sand, volatilizing at room temperature for 20 h, then putting the mixed quartz sand into an electrothermal blowing dry box, warming according to temperature programming of 60° C., 80° C., 100° C. and 120° C., each for 2 h and at intervals of 1 h, keeping a constant temperature at 120° C. for 2 h and then turning off the dry box for natural cooling to the room temperature, where this warming process guarantees that an oil film on the surface of sand grains does not burst during rapid warming; and preparing neutral and water-wet cores with untreated quartz sand and epoxy resin, 20% dibutyl phthalate as a flexibilizer and 7% ethanediamine as a curing agent, where the prepared artificial cores have neutral and slightly oil-wet properties.

As a preferred solution of the method and device for preparing an artificial core for petroleum geological exploration in the present disclosure, during sand filling, sand is added each time in an appropriate amount and at an appropriate thickness to avoid local compaction, and the sand added each time needs to be carded and flattened.

As a preferred solution of the method and device for preparing an artificial core for petroleum geological exploration in the present disclosure, a specific operation method in step 4 includes:

(1) fully agitating the quartz sand with the epoxy resin in a certain proportion and putting a resulting mixture into a prepared evacuator; (2) saturating the mixture with a water-based clay suspension of a known composition such that the sand mold is in full contact with or adsorbs the clay in the water; then removing the water-based clay suspension, repeating the above process for a plurality of times, and finally drying the water-based clay suspension and weighing the residual clay to obtain an amount of the adsorbed clay; and (3) putting suction-filtered sand mold into a mold, and pressurizing and drying.

As a preferred solution of the method and device for preparing an artificial core for petroleum geological exploration in the present disclosure, a drum, an agitating impeller and a main box of the agitator in step 3 are all controlled to rotate in different directions such that the quartz sand is agitated therein in a three-dimensional rotational manner, avoiding nonuniform manual agitation of the quartz sand and guaranteeing that porosities, permeability values, pore structures and rock grain size distributions at all points of the artificial core are respectively consistent.

As a preferred solution of the method and device for preparing an artificial core for petroleum geological exploration in the present disclosure, the device is applied to the above-described method for preparing an artificial core for petroleum geological exploration.

As a preferred solution of the method and device for preparing an artificial core for petroleum geological exploration in the present disclosure, the device includes a screening assembly, an agitating assembly, an evacuating assembly and a drying assembly.

As a preferred solution of the method and device for preparing an artificial core for petroleum geological exploration in the present disclosure, the agitating assembly is an agitator; and a drum, an agitating impeller and a main box of the agitator are all controlled to rotate in different directions such that quartz sand is agitated therein in a three-dimensional rotational manner.

As a preferred solution of the method and device for preparing an artificial core for petroleum geological exploration in the present disclosure, the screening assembly includes a 20 to 80-mesh sieve mesh and a vibration motor; the evacuating assembly includes a vacuum pump and a suction filtration pump; and the drying assembly includes an electrothermal blowing dry box, a constant temperature box and a cooling box.

Compared with the prior art, the present disclosure has the following beneficial effects: The three-dimensional rotational manner of quartz sand in the agitator works out the nonuniform manual agitation of the quartz sand, which guarantees consistence in porosities, permeability values, pore structures and rock grain size distributions of the artificial core. Cores different in permeability are closer to each other in pore structure and thus are more scientific and practical. A cementing agent is prepared by using the above method. No matter how the sand mold changes, an optimum content of the cementing agent can be guaranteed such that the artificial core has consistent hardness, consistent uniformity degree and consistent oil displacement effect after bearing a high temperature and a high pressure.

### BRIEF DESCRIPTION OF THE DRAWINGS

To describe the technical solutions in the embodiments of the present disclosure more clearly, the present disclosure will be described in detail below in conjunction with the accompanying drawings and the specific embodiments. Apparently, the drawings in the following description show merely some embodiments of the present disclosure, and other drawings may be derived from these drawings by those of ordinary skill in the art without creative efforts. In the drawings:

FIG. 1 is a flowchart of the present disclosure.

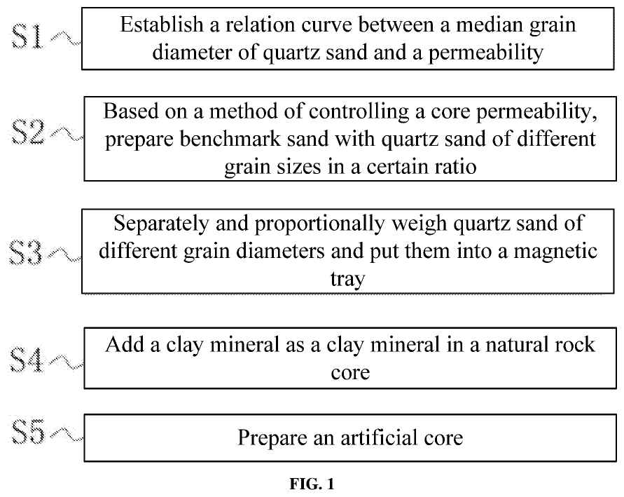

### DETAILED DESCRIPTION OF THE EMBODIMENTS

To make the foregoing objective, features, and advantages of the present disclosure clearer and more comprehensible, a specific embodiment of the present disclosure is described in detail below with reference to the accompanying drawings.

Many specific details are set forth in the following descriptions to facilitate full understanding of the present disclosure, but the present disclosure may also be implemented in other ways that are different from those described herein. Similar derivatives may be made by those skilled in the art without departing from the connotation of the present disclosure, and therefore, the present disclosure is not limited by the specific embodiment disclosed below.

Secondly, the present disclosure is described in detail in combination with the figure. When the embodiment of the present disclosure is described in detail, for the convenience of description, a sectional view of a structure of a device will not be locally enlarged according to a general scale, and the figure shows merely an example and may not limit the protection scope of the present disclosure. In addition, dimensions in a three-dimensional (3D) space including a length, width and depth should be provided in actual manufacture.

In order to make the objective, technical solutions and advantages of the present disclosure clearer, the embodiment of the present disclosure will be further described in detail in combination with the accompanying drawings.

### EXAMPLE 1

Provided are a method and device for preparing an artificial core for petroleum geological exploration. The method includes the following steps:
step 1, establish a relation curve between a median grain diameter of quartz sand and a permeability, determine a type and a usage amount of epoxy resin, and prepare a cementing agent according to a principle that the epoxy resin has a direct ratio with a specific surface;
step 2, based on a method of controlling a core permeability, prepare benchmark sand with quartz sand of different grain sizes in a certain ratio, fabricate a low-permeability core by adjusting a ratio of the benchmark sand to fine sand, and fabricate a high-permeability core by adjusting a ratio of the benchmark sand to coarse sand;
step 3, separately and proportionally weigh quartz sand of different grain diameters and putting them into a magnetic tray, and manually mix and agitate for later use, where since agitating frequency, times and uniformity degree for per capita have a great influence on porosity and permeability values of an artificial core during stirring, and a quartz sand mixing agitator is employed to avoid man-made nonuniform agitation;
step 4, add a clay mineral, where a clay mineral in a natural rock core plays an important role on a structure and physical properties of the rock core; according to a principle of physical simulation similarity criterion, a certain amount of clay mineral is added to an artificial core; and a special method of adding the clay mineral is used to avoid the clay mineral from being covered with the epoxy resin; and
step 5, prepare an artificial core: prepare a slightly oil-wet core by diluting silicone oil which is 10% by weight of a sand mold with 20 times petroleum ether, evenly agitating the diluted silicone oil with 40 to 70-mesh quartz sand, 70 to 140-mesh quartz sand and 140 to 200-mesh quartz sand, volatilizing at room temperature for 20 h, then putting the mixed quartz sand into an electrothermal blowing dry box, warming according to temperature programming of 60° C., 80° C., 100° C. and 120° C., each for 2 h and at intervals of 1 h, keeping a constant temperature at 120° C. for 2 h and then turning off the dry box for natural cooling to the room temperature, where this warming process guarantees that an oil film on the surface of sand grains does not burst during rapid warming; and prepare neutral and water-wet cores with untreated quartz sand and epoxy resin, 20% dibutyl phthalate as a flexibilizer and 7% ethanediamine as a curing agent, where the prepared artificial cores have neutral and slightly oil-wet properties.

Specifically, the following must be noted during sand filling: sand should be added each time in an appropriate amount and at an appropriate thickness to avoid local compaction, and the sand added each time needs to be carded and flattened.

Specifically, a specific operation method in step 4 includes:
(1) fully agitate the quartz sand with the epoxy resin in a certain proportion and put a resulting mixture into a prepared evacuator; (2) saturate the mixture with a water-based clay suspension of a known composition such that the sand mold is in full contact with or adsorbs the clay in the water; then remove the water-based clay suspension, repeat the above process for a plurality of times, and finally dry the water-based clay suspension and weigh the residual clay to obtain an amount of the adsorbed clay; and (3) put suction-filtered sand mold into a mold, and perform pressurizing and drying.

Specifically, a drum, an agitating impeller and a main box of the agitator in step 3 are all controlled to rotate in different directions such that the quartz sand is agitated therein in a three-dimensional rotational manner, avoiding nonuniform manual agitation of the quartz sand and guaranteeing that porosities, permeability values, pore structures and rock grain size distributions at all points of the artificial core are respectively consistent.

Specifically, the device includes a screening assembly, an agitating assembly, an evacuating assembly and a drying assembly, where the agitating assembly is an agitator; and a drum, an agitating impeller and a main box of the agitator are all controlled to rotate in different directions such that quartz sand is agitated therein in a three-dimensional rotational manner; the screening assembly includes a 20 to 80-mesh sieve mesh and a vibration motor; the evacuating assembly includes a vacuum pump and a suction filtration pump; and the drying assembly includes an electrothermal blowing dry box, a constant temperature box and a cooling box.

Working Principle: during the use of the present disclosure, the quartz sand is agitated within the agitator in a three-dimensional rotational manner, avoiding nonuniform manual agitation of the quartz sand and guaranteeing that porosities, permeability values, pore structures and rock grain size distributions at all points of the artificial core are respectively consistent. Cores different in permeability are closer to each other in pore structure and thus are more scientific and practical. A cementing agent is prepared by using the formula described above. No matter how the sand mold changes, an optimum content of the cementing agent can be guaranteed such that the artificial core has consistent hardness, consistent uniformity degree and consistent oil displacement effect after bearing a high temperature and a high pressure.

Although the present disclosure has been described above with reference to the embodiment, various improvements can be made thereto and components therein can be replaced with equivalents without departing from the scope of the present disclosure. In particular, as long as there is no structural conflict, various features in the embodiment disclosed in the present disclosure can be combined with each other in any manner. These combinations are not exhaustively described in this description only for the sake of omitting space and saving resources. The present disclosure is not limited to the specific embodiment disclosed herein, but shall include all technical solutions falling within the scope of the claims.

What is claimed is:

1. A method for preparing an artificial core for petroleum geological exploration, comprising the following steps:
step 1, establishing a relation curve between a median grain diameter of quartz sand and a permeability, determining a type and a usage amount of epoxy resin, and preparing a cementing agent according to a principle that the epoxy resin has a direct ratio with a specific surface;
step 2, based on a method of controlling a core permeability, preparing benchmark sand with quartz sand of different grain sizes in a certain ratio, fabricating a low-permeability core by adjusting a ratio of the benchmark sand to fine sand, and fabricating a high-permeability core by adjusting a ratio of the benchmark sand to coarse sand;
step 3, separately and proportionally weighing quartz sand of different grain diameters and putting them into a magnetic tray, and manually mixing and agitating for later use, wherein since agitating frequency, times and uniformity degree for per capita have a great influence on porosity and permeability values of an artificial core during stirring, and a quartz sand mixing agitator is employed to avoid man-made nonuniform agitation;
step 4, adding a clay mineral, wherein a clay mineral in a natural rock core plays an important role on a structure and physical properties of the rock core; according to a principle of physical simulation similarity criterion, a certain amount of clay mineral is added to an artificial core; and a special method of adding the clay mineral is used to avoid the clay mineral from being covered with the epoxy resin; and
step 5, preparing an artificial core: preparing a slightly oil-wet core by diluting silicone oil which is 10% by weight of a sand mold with 20 times petroleum ether, evenly agitating the diluted silicone oil with 40 to 70-mesh quartz sand, 70 to 140-mesh quartz sand and 140 to 200-mesh quartz sand, volatilizing at room temperature for 20 h, then putting the mixed quartz sand into an electrothermal blowing dry box, warming according to temperature programming of 60° C., 80° C., 100° C. and 120° C., each for 2 h and at intervals of 1 h, keeping a constant temperature at 120° C. for 2 h and then turning off the dry box for natural cooling to the room temperature, wherein the warming process guarantees that an oil film on the surface of sand grains does not burst during rapid warming; and preparing neutral and water-wet cores with untreated quartz sand and epoxy resin, 20% dibutyl phthalate as a flexibilizer and 7% ethanediamine as a curing agent, wherein the prepared artificial cores have neutral and slightly oil-wet properties.

2. The method for preparing an artificial core for petroleum geological exploration according to claim 1, wherein during sand filling, sand is added each time in an appropriate amount and at an appropriate thickness to avoid local compaction, and the sand added each time needs to be carded and flattened.

3. The method for preparing an artificial core for petroleum geological exploration according to claim 1, wherein a specific operation method in step 4 comprises:
(1) fully agitating the quartz sand with the epoxy resin in a certain proportion and putting a resulting mixture into a prepared evacuator; (2) saturating the mixture with a water-based clay suspension of a known composition such that the sand mold is in full contact with or adsorbs the clay in the water; then removing the water-based clay suspension, repeating the above process for a plurality of times, and finally drying the water-based clay suspension and weighing the residual clay to obtain an amount of the adsorbed clay; and (3) putting suction-filtered sand mold into a mold, and pressurizing and drying.

4. The method for preparing an artificial core for petroleum geological exploration according to claim 1, wherein a drum, an agitating impeller and a main box of the agitator in step 3 are all controlled to rotate in different directions such that the quartz sand is agitated therein in a three-dimensional rotational manner, avoiding nonuniform manual agitation of the quartz sand and guaranteeing that porosities, permeability values, pore structures and rock grain size distributions at all points of the artificial core are respectively consistent.

5. A device for preparing an artificial core for petroleum geological exploration, applied to the method for preparing an artificial core for petroleum geological exploration according to claim 1.

6. The device for preparing an artificial core for petroleum geological exploration according to claim 5, wherein during sand filling, sand is added each time in an appropriate amount and at an appropriate thickness to avoid local compaction, and the sand added each time needs to be carded and flattened.

7. The device for preparing an artificial core for petroleum geological exploration according to claim 5, wherein a specific operation method in step 4 comprises:
(1) fully agitating the quartz sand with the epoxy resin in a certain proportion and putting a resulting mixture into a prepared evacuator; (2) saturating the mixture with a water-based clay suspension of a known composition such that the sand mold is in full contact with or adsorbs the clay in the water; then removing the water-based clay suspension, repeating the above process for a plurality of times, and finally drying the water-based clay suspension and weighing the residual clay to obtain an amount of the adsorbed clay; and (3) putting suction-filtered sand mold into a mold, and pressurizing and drying.

8. The device for preparing an artificial core for petroleum geological exploration according to claim 5, wherein a drum, an agitating impeller and a main box of the agitator in step 3 are all controlled to rotate in different directions such that the quartz sand is agitated therein in a three-dimensional rotational manner, avoiding nonuniform manual agitation of the quartz sand and guaranteeing that porosities, permeability values, pore structures and rock grain size distributions at all points of the artificial core are respectively consistent.

9. The device for preparing an artificial core for petroleum geological exploration according to claim 5, comprising a screening assembly, an agitating assembly, an evacuating assembly and a drying assembly.

10. The device for preparing an artificial core for petroleum geological exploration according to claim 6, comprising a screening assembly, an agitating assembly, an evacuating assembly and a drying assembly.

11. The device for preparing an artificial core for petroleum geological exploration according to claim 7, comprising a screening assembly, an agitating assembly, an evacuating assembly and a drying assembly.

12. The device for preparing an artificial core for petroleum geological exploration according to claim 8, comprising a screening assembly, an agitating assembly, an evacuating assembly and a drying assembly.

13. The device for preparing an artificial core for petroleum geological exploration according to claim 5, wherein the agitating assembly is an agitator; and a drum, an agitating impeller and a main box of the agitator are all controlled to rotate in different directions such that quartz sand is agitated therein in a three-dimensional rotational manner.

14. The device for preparing an artificial core for petroleum geological exploration according to claim 6, wherein the agitating assembly is an agitator; and a drum, an agitating impeller and a main box of the agitator are all controlled to rotate in different directions such that quartz sand is agitated therein in a three-dimensional rotational manner.

15. The device for preparing an artificial core for petroleum geological exploration according to claim 7, wherein the agitating assembly is an agitator; and a drum, an agitating impeller and a main box of the agitator are all controlled to rotate in different directions such that quartz sand is agitated therein in a three-dimensional rotational manner.

16. The device for preparing an artificial core for petroleum geological exploration according to claim 8, wherein the agitating assembly is an agitator; and a drum, an agitating impeller and a main box of the agitator are all controlled to rotate in different directions such that quartz sand is agitated therein in a three-dimensional rotational manner.

17. The device for preparing an artificial core for petroleum geological exploration according to claim 5, wherein the screening assembly comprises a 20 to 80-mesh sieve mesh and a vibration motor; the evacuating assembly comprises a vacuum pump and a suction filtration pump; and the drying assembly comprises an electrothermal blowing dry box, a constant temperature box and a cooling box.

18. The device for preparing an artificial core for petroleum geological exploration according to claim 6, wherein the screening assembly comprises a 20 to 80-mesh sieve mesh and a vibration motor; the evacuating assembly comprises a vacuum pump and a suction filtration pump; and the drying assembly comprises an electrothermal blowing dry box, a constant temperature box and a cooling box.

19. The device for preparing an artificial core for petroleum geological exploration according to claim 7, wherein the screening assembly comprises a 20 to 80-mesh sieve mesh and a vibration motor; the evacuating assembly comprises a vacuum pump and a suction filtration pump; and the drying assembly comprises an electrothermal blowing dry box, a constant temperature box and a cooling box.

20. The device for preparing an artificial core for petroleum geological exploration according to claim 8, wherein the screening assembly comprises a 20 to 80-mesh sieve mesh and a vibration motor; the evacuating assembly comprises a vacuum pump and a suction filtration pump; and the drying assembly comprises an electrothermal blowing dry box, a constant temperature box and a cooling box.
